(19) United States
(12) Patent Application Publication
(10) Pub. No.: US 2026/0233588 A1
(43) Pub. Date: Aug. 13, 2026

(54) Door drive device for adjusting a vehicle door relative to a vehicle body

(71) Applicant: Brose Fahrzeugteile SE & Co. Kommanditgesellschaft, Bamberg, Bamberg (DE)

(72) Inventors: Tobias GAGEL, Zapfendorf (DE); Daniel SCHNAPP, Ebensfeld (DE)

(21) Appl. No.: 19/540,147

(22) Filed: Feb. 13, 2026

(30) Foreign Application Priority Data
Feb. 13, 2025 (DE) 102025105412.6

(51) Int. Cl. B60J 5/04; B60J 5/06; E05F 15/622; E05F 15/646

(52) U.S. Cl. CPC B60J 5/04; B60J 5/06; E05F 15/622; E05F 15/646; E05Y 2900/531

(57) ABSTRACT

comprises a motor, a transmission, and a spindle rotatable about a longitudinal axis, wherein the motor is operatively connected to the spindle via the transmission and the spindle can be driven by the motor to rotate about the longitudinal axis. A spindle nut element has a threaded connection with the spindle, such that, by rotating the spindle, the spindle nut element can be moved along an adjustment direction oriented along the longitudinal axis relative to the spindle. A guide rail serves to guide the spindle nut element during movement along the adjustment direction. The guide rail is formed in a sheet metal bending process and has a profile that is circumferentially closed around the adjustment direction.

### CROSS-REFERENCE TO RELATED APPLICATIONS

This application claims priority pursuant to 35 U.S.C. 119(a) to German Application No. 102025105412.6, filed Feb. 13, 2025, which application is incorporated herein by reference in its entirety.

### FIELD OF THE INVENTION

The disclosure relates to a door drive device for moving a vehicle door relative to a vehicle body.

Such a door drive device comprises a motor, a transmission and a spindle rotatable about a longitudinal axis. The motor is operatively connected to the spindle via the transmission, so that the spindle can be rotated around the longitudinal axis by the motor. A spindle nut element has a threaded connection to the spindle in such a way that by rotating the spindle the spindle nut element can be moved relative to the spindle along an adjustment direction oriented along the longitudinal axis. A guide rail is designed to guide the spindle nut element during movement along the adjustment direction. A push rod is connected to the spindle nut element to transmit an adjusting force between the vehicle door and the vehicle body.

### BACKGROUND OF THE INVENTION

A door drive device for moving a vehicle door relative to a vehicle body is known, for example, from DE 10 2018 131 933 A1.

A further design of a door drive device having a spindle drive is known from WO 2021/023893 A1.

In a door drive device known from WO 2024/193762 A1, a guide rail is formed for guiding a slide arrangement through a circumferentially closed extruded aluminum profile.

In a door drive device where an adjusting force between a vehicle door and a vehicle body is effected by moving a spindle nut element along a guide rail, there is a need for a cost-effective design. It is particularly desirable to design the guide rail with a fully circumferentially enclosed profile in order to protect the interior of the guide rail from environmental influences such as dirt ingress. However, it should be noted that a clearance may need to be provided on the guide rail to connect the guide rail to a transmission housing, which involves considerable effort for post-processing if the guide rail is manufactured as an (aluminum) extruded profile or as a (plastic) extruded profile.

### SUMMARY OF THE INVENTION

The purpose of the proposed solution is to provide a door drive device for adjusting a vehicle door that offers a cost-effective design and also protects a rail system from environmental influences.

This object is achieved by a door drive device for adjusting a vehicle door having the features described herein.

Accordingly, the guide rail is formed in a sheet metal bending process and has a profile that is completely closed circumferentially around the adjustment direction.

Forming the guide rail as an integral, one-piece component using a sheet metal bending process makes it possible to manufacture the guide rail cost-effectively. Because the guide rail is manufactured by forming in a sheet metal bending process, a metal sheet, in particular a steel sheet, can be used to manufacture the guide rail, which opens up the possibility of a particularly cost-effective manufacturing of the guide rail.

In particular, the guide rail can be formed as a punched and bent part from a sheet of metal, especially a sheet of steel. Manufacturing the guide rail as a punched and bent part makes it possible, in particular, to form a clearance-for example, via which the guide rail can be connected to a transmission housing-on the guide rail before forming the metal sheet to form the guide rail. By punching the metal sheet and subsequently forming it using a bending process, the guide rail can be variably adapted in its shape and also manufactured cost-effectively.

The guide rail has a closed profile, at least in axial regions (viewed along the adjustment direction) where no clearance is provided for connecting the guide rail to a housing assembly, in particular a transmission housing. Due to the circumferentially closed profile formed by sheet metal bending, dirt cannot easily enter the interior of the guide rail from the outside, thus protecting the system composed of the guide rail and spindle nut element from environmental influences in order to maintain consistent sliding properties and consequently consistent sliding forces, low wear, and good acoustics over the service life of the door drive device.

In one embodiment, sheet metal portions of the guide rail which are bent towards each other in the adjustment direction are connected to each other at a connecting point. The guide rail is formed in the sheet metal bending process in such a way that the guide rail has a circumferentially closed profile. The sheet metal portions bent towards each other are connected to one another, so that the guide rail is permanently completely closed and dirt ingress is prevented even at a seam between the sheet metal portions.

In one embodiment, the sheet metal portions are connected to each other longitudinally along the adjustment direction at the connecting point. The sheet metal portions are bent towards each other in the adjustment direction. At the connecting point, an approximately linear connection, running lengthwise along the adjustment direction, is formed between the sheet metal portions. The sheet metal portions are permanently and reliably connected to each other during operation by this linear connection.

In one embodiment, the sheet metal portions are connected to each other at the connecting point by a form-fit, friction-fit, or material-fit connection.

In principle, any joining method for connecting the sheet metal portions at the connecting point is conceivable and possible. Different joining methods are defined, for example, in the standard DIN 8593.

For example, the sheet metal portions can be joined together at the connecting point by clinching, clipping, riveting or flanging.

Clinching—also called pressure joining or press joining—is a joining method in manufacturing technology in which sheet metal portions are joined together using a press joining tool in a cold forming process. A clinching tool consists of a punch and a die. The sheet metal portions to be joined (joining parts) are pressed into the die by the punch, producing a plastic deformation, similarly to deep drawing. A special design of the die creates a snap-button-like shape that connects the sheet metal portions (joining parts) with a positive and non-positive connection.

The sheet metal portions can also be connected to each other by means of a clip connection, for example by forming clip elements on one sheet metal portion to engage in corresponding clip openings on the other sheet metal portion.

A riveted or screw connection between the sheet metal portions is also possible.

During flanging, folds are formed on the sheet metal portions, which allow the sheet metal portions to be connected, for example by inserting the folds into each other.

Additionally, or alternatively, the sheet metal portions can be joined together at the connecting point by welding or gluing, thus creating a material-bonded connection. For example, the sheet metal portions can be joined together at the connecting point using a laser welding connection, such that the sheet metal portions are placed butt-jointed, for example, and then joined together at the joint by laser welding.

In one embodiment, the edges of the sheet metal portions are butted together at the connecting point and thus lie flush against each other at the connecting point. The edges of the sheet metal portions can be joined together at the connecting point, for example by material bonding through welding, such as laser welding, or with a positive connection through a suitable positive connection between the edges.

For example, in a process also known as “roll and lock”, the edges can be connected to each other via positive-connecting portions that engage in positive openings. The edges are basically butted against each other. The positive-connection portions and the positive-connection openings are formed in the plane of the sheet metal portions, wherein an arrangement of positive-connection openings and/or positive-connection portions is formed on one edge and a complementary arrangement is formed on the other edge, so that the sheet metal portions are joined together without material thickening by the engagement of the positive-connection portions in the positive-connection openings.

The forming process to produce the circumferentially closed profile and the joining at the connecting point can be carried out in a single operation by engaging the positive-connection portions and the positive-connection openings with each other during the forming process, thus joining the sheet metal portions of the sheet metal part forming the guide rail at the connecting point.

In one embodiment, the guide rail is axially closed by a cover element. Such a cover element can close off the guide rail, particularly at a free end, for example, at an end located away from a housing assembly that constitutes a transmission housing, so that dirt ingress into the interior of the guide rail is prevented at the axial end of the guide rail during operation.

In one embodiment, the guide rail has a sliding guide portion for guiding the spindle nut element along the adjustment direction, and a spindle housing portion for receiving the spindle. The spindle nut element can, for example, have a sliding portion for sliding along the sliding guide portion. The spindle nut element is thus guided slidably on the sliding guide portion, for example between parallel legs of the sliding guide portion.

On the sliding guide portion, the spindle nut element is guided over the sliding portion in such a way that the spindle nut element is supported in its rotational position (about the longitudinal axis) via the guide rail. When the spindle rotates, the spindle nut element cannot rotate with it, but is fixed in its rotational position via the guide rail, so that the rotational movement of the spindle is converted into a longitudinal movement of the spindle nut element along the adjustment direction due to the threaded engagement.

In one embodiment, the connecting point is located on the sliding guide portion or on the spindle housing portion.

The connecting point can, for example, be formed on an upper wall of the spindle housing portion, located away from the sliding guide portion. Providing the connecting point in the area of the spindle housing portion can have the particular advantage that the sliding guidance of the spindle nut element on the sliding guide portion is not impaired by the connecting point.

In another embodiment, the connecting point can also be formed, for example, on a lower wall of the sliding guide portion facing away from the spindle housing portion.

In one embodiment, the spindle nut element has a spindle nut portion which has a threaded engagement with the spindle. The spindle nut portion is movable within the spindle housing portion along the adjustment direction. The spindle is housed within the spindle housing portion. The spindle housing portion extends lengthwise along the longitudinal axis. A threaded opening is formed on the spindle nut portion, through which the spindle passes, the spindle engaging via an external thread with an internal thread within the threaded opening such that, when the spindle rotates, the spindle nut element is moved longitudinally along the longitudinal axis relative to the spindle.

In one embodiment, viewed along the adjustment direction, the guide rail has a clearance in an axial region in which the guide rail is fully open. In the region of the clearance, the guide rail is therefore not completely closed.

For example, the spindle housing portion can be left out in the region of the clearance. The sliding guide portion can, for example, also extend into the axial region of the clearance, so that a guide for the spindle nut element also exists in the region of the clearance on the guide rail.

In one embodiment, the door drive device has a housing assembly that encloses at least one gear wheel of the transmission and carries the motor. In one embodiment, the guide rail is attached to the housing assembly in the region of the clearance. The clearance allows, in particular, a gear wheel, which is rotationally fixed to the spindle and arranged coaxially with the spindle, to be arranged on the guide rail in an area axially aligned with the spindle housing portion. In the region of the clearance, the housing assembly projects into a region aligned with the spindle housing portion of the guide rail, so that the housing assembly with the gear wheel mounted therein is aligned with the spindle within the spindle housing portion of the guide rail.

For example, a gear wheel is connected for conjoint rotation to the spindle and can be driven by the motor. For example, the gear wheel is formed by a spur gear which engages with a drive worm arranged on the motor shaft, so that, by driving the drive worm, the gear wheel can be set into a rotary motion about the longitudinal axis and thus the spindle can be rotated. Both the gear wheel and the drive worm are preferably enclosed in the housing assembly and, in advantageous embodiments, are rotatably mounted in the housing assembly.

The sliding guide portion of the guide rail can extend in the adjustment direction under the housing assembly, so that the spindle nut element is still guided on the sliding guide portion of the guide rail in an area that axially overlaps with the housing assembly.

For example, the sliding portion of the spindle nut element can have a greater length axially along the adjustment direction than the spindle nut portion. In a position close to the housing assembly, corresponding to an extended position of the push rod, the sliding portion can engage under the transmission housing, while the spindle nut portion of the spindle nut element is arranged axially next to the housing assembly. This allows for a compact, axially-short design of the door drive device, provided the spindle nut element has favorable guiding properties on the guide rail.

In one embodiment, the guide rail has at least one first fastening tab for connection to the housing assembly. In particular, a screw connection to the housing assembly can be made via such a fastening tab. The first or at least one fastening tab is bent over on the guide rail, for example on the spindle housing portion, such that the first or at least one fastening tab extends along a plane perpendicular to the adjustment direction.

In one embodiment, the housing assembly can be moved about the longitudinal axis relative to the guide rail in a pre-assembly state.

Such mobility in a pre-assembly state, in which the housing assembly is not yet fixed to the guide rail, makes it possible to align a motor axis of the motor, about which a motor shaft of the motor can be rotated, in its angular position relative to the longitudinal axis of the spindle, such that the motor can be connected to the guide rail in different angular positions around the longitudinal axis via the housing assembly.

For this purpose, at least one first fastening tab can, for example, have a curved, elongated hole that allows the housing assembly to be attached to the guide rail in different angular positions of the housing assembly relative to the guide rail.

In one embodiment, a component unit from the group of housing assembly and guide rail has a support element which, in the pre-assembly state, is supported on the other component unit from the group of housing assembly and guide rail in a manner movable about the longitudinal axis. The support element is arranged accordingly on the housing assembly or on the guide rail and supported on the other component unit. The support element can, for example, provide axial support for the guide rail and the housing assembly relative to each other. The support is designed in such a way that, in the pre-assembly state, the housing assembly can be moved about the longitudinal axis at least within a certain angular range relative to the guide rail.

In one embodiment, the support element has (at least) one support leg which engages in a slot opening of the other component unit from the group of housing assembly and guide rail and is movable in the slot opening about the longitudinal axis. The support leg and the slot opening can, for example, each extend along a plane perpendicular to the longitudinal axis. The support leg engages in the slot opening, thus providing axial support between the housing assembly and the guide rail. However, the support leg is movable about the longitudinal axis in the slot opening, so that the position of the housing assembly can (also) be adapted relative to the guide rail.

In one embodiment, the push rod is articulatedly connected to the spindle nut element. A pivot axis about which the push rod can be pivoted relative to the spindle nut element is in particular oriented perpendicular to the longitudinal axis of the spindle. The push rod can thus perform a compensating movement in an axis perpendicular to the pivot axis relative to the spindle nut element in order to compensate for a change in the position of the vehicle door relative to the vehicle body during an adjustment movement of the vehicle door.

In one embodiment, the door drive device has an adapter element for connecting the door drive device to the vehicle door or the vehicle body. The adapter element has an opening through which the push rod extends in the installed position. The door drive device can be positioned in the vehicle, for example on the vehicle door, via the adapter element, which is specifically adapted for a particular vehicle model and thus enables the door drive device to be connected to an associated vehicle assembly in that vehicle model.

In one embodiment, the adapter element has at least one fastening element for firmly connecting the adapter element to the vehicle door or the vehicle body. Such a fastening element can, for example, be formed by a screw, so that the adapter element can be screwed to the vehicle body or the vehicle door and thus firmly connected to the vehicle body or the vehicle door.

By moving the spindle nut element, to which the push rod is preferably articulated, the push rod can be moved relative to the adapter element and, for example, can be adjusted between a retracted position and an extended position relative to the adapter element. In the retracted position, one end of the push rod, located away from the spindle nut element, is approaching the adapter element. In the extended position, the end of the push rod located away from the spindle nut element is, by contrast, further away from the adapter element. If the adapter element is connected to the door frame of a vehicle door, the end of the push rod located away from the spindle nut element is connected to the vehicle body, so that, by moving the push rod, the vehicle door can be moved relative to the vehicle body. The door drive device can preferably be arranged inside the door box and thus inside the vehicle door, with the push rod extending through the opening in the adapter element and through a door inner panel surrounding the door box.

In one embodiment, the guide rail is connected to a fastening interface of the adapter element. The guide rail is thus fixed to the adapter element.

In one embodiment, the housing assembly is connected to the adapter element. The housing assembly can, in particular, constitute a transmission housing in which components of the transmission are enclosed. The housing assembly supports the motor and connects the motor to the adapter element.

In one embodiment, the guide rail has at least one second fastening tab for connection to the adapter element. A screw connection between the guide rail and the adapter element can be established, in particular, via at least one second fastening tab.

In one embodiment, the at least one second fastening tab is bent over on the guide rail, for example on the sliding guide portion of the guide rail, such that the at least one second fastening tab extends along a plane perpendicular to the adjustment direction. For example, a screw opening can be formed on the fastening tab, through which the guide rail is screwed to the adapter element.

Instead of such a second fastening tab, a mounting bracket can also be arranged on the guide rail as a separate component, which is fixed to the guide rail, for example by so-called toxing, clinching, welding or riveting. The guide rail can be fixed to the adapter element via the mounting bracket, for example by screwing it in place.

In general, the guide rail can be shaped, for example, with or without fastening tabs for attachment to the adapter element and the housing assembly. If no fastening tabs are integrally formed on the guide rail, the manufacturing of the guide rail can be further simplified because, for example, a bending process to fold over the fastening tabs is not required. In this case, the guide rail can, for example, be attached to the adapter element via a separate mounting bracket and supported on the housing assembly via a support element.

In one embodiment, a channel for draining moisture is formed on a bottom wall of the guide rail. In a standard installation position of the door drive device in a vehicle (with reference to the direction of gravity), the bottom wall of the guide rail is located at the bottom, so that moisture generally collects in the area of the bottom wall in the guide rail. In the intended installation position, the floor wall can be inclined so that moisture can run off along the channel formed on the bottom wall, for example towards a drain opening in the area of a front end of the guide rail facing the adapter element.

### BRIEF DESCRIPTION OF THE DRAWINGS

The idea underlying the proposed invention will be explained in more detail below with reference to the exemplary embodiments shown in the figures. In the figures:

FIG. 1 shows a schematic view of a vehicle door on a vehicle body;

FIG. 2 shows an exemplary embodiment of a door drive device for adjusting the vehicle door relative to the vehicle body, in an extended position of a push rod;

FIG. 3 shows another view of the door drive device;

FIG. 4 shows a view of the door drive device without a guide rail;

FIG. 5 shows another view of the arrangement according to FIG. 4;

FIG. 6 shows a view of the door drive device (without the guide rail) in a retracted position of the push rod;

FIG. 7 shows a view of the door drive device, without the push rod, a spindle nut element and a motor;

FIG. 8 shows another view of the arrangement according to FIG. 7;

FIG. 9 shows a view of a housing assembly of the door drive device together with a spindle;

FIG. 10 shows another view of the arrangement according to FIG. 9;

FIG. 11 shows a frontal view of the arrangement according to FIGS. 9 and 10;

FIG. 12 shows a view of an adapter element together with the spindle, the spindle nut element and the push rod;

FIG. 13 shows a separate view of the adapter element;

FIG. 14 shows another view of the adapter element;

FIG. 15 shows a partially enlarged view of the housing assembly together with the guide rail;

FIG. 16A shows a separate view of the guide rail;

FIG. 16B shows another view of the guide rail;

FIG. 17 shows a view of the guide rail with a mounting bracket for attachment to the adapter element;

FIG. 18 shows a schematic view of a connecting point where sheet metal portions of the guide rail bent towards each other are connected to each other using a so-called “roll and lock” method to produce a circumferentially closed profile;

FIG. 19 shows a schematic view of a further example of a connecting point;

FIG. 20 shows a schematic view of yet another example of a connecting point;

FIG. 21 shows a schematic view of yet another example of a connecting point;

FIG. 22 shows a view of a door drive device with a guide rail, according to a further exemplary embodiment;

FIG. 23 shows a separate view of the guide rail with fastening tabs formed on the guide rail for connecting the guide rail to a transmission housing and an adapter element;

FIG. 24 shows a view of a door drive device with a guide rail, according to a further exemplary embodiment; and,

FIG. 25 shows an enlarged partial sectional view of the door drive device, depicting a support element on a housing assembly for supporting the guide rail.

### DETAILED DESCRIPTION OF THE INVENTION

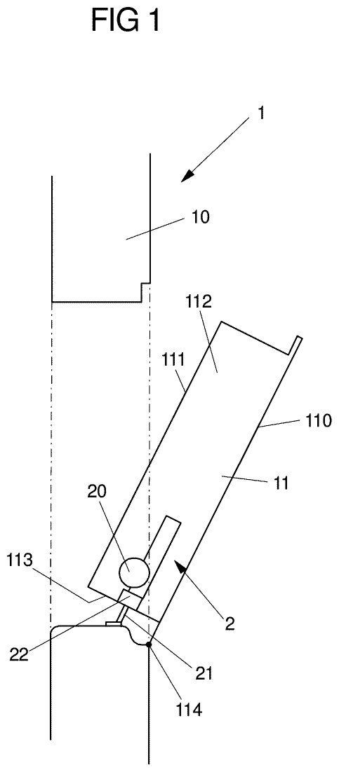

FIG. 1 shows a schematic view of a detail of a vehicle 1, which has a vehicle body 10 and a vehicle door 11 arranged pivotably on the vehicle body 10 about a hinge axis 114.

The vehicle door 11 can be pivoted about the hinge axis 114 relative to the vehicle body 10 in order to close an opening in the vehicle body 10 in a closed position or to release it in an open position, so that a user can enter the vehicle 1 or exit the vehicle 1. The vehicle door 11 can, in particular, be a front side door or a rear side door.

The vehicle door 11 has a door outer panel 110 and a door inner panel 113, which together with a door module 111 attached to the door inner panel 113 define a door box that encloses a door interior 112.

In the illustrated exemplary embodiment, a door drive device 2 is arranged within the vehicle door 11 and is designed for electrically adjusting the vehicle door 11 relative to the vehicle body 10 or at least for electrically assisted, manual adjustment of the vehicle door 11 relative to the vehicle body 10.

In the illustrated exemplary embodiment, the door drive device 2 has a motor 20 implemented by an electric motor and a push rod 21 which can be adjusted by the motor 20 in order to effect an adjusting force between the vehicle door 11 and the vehicle body 10.

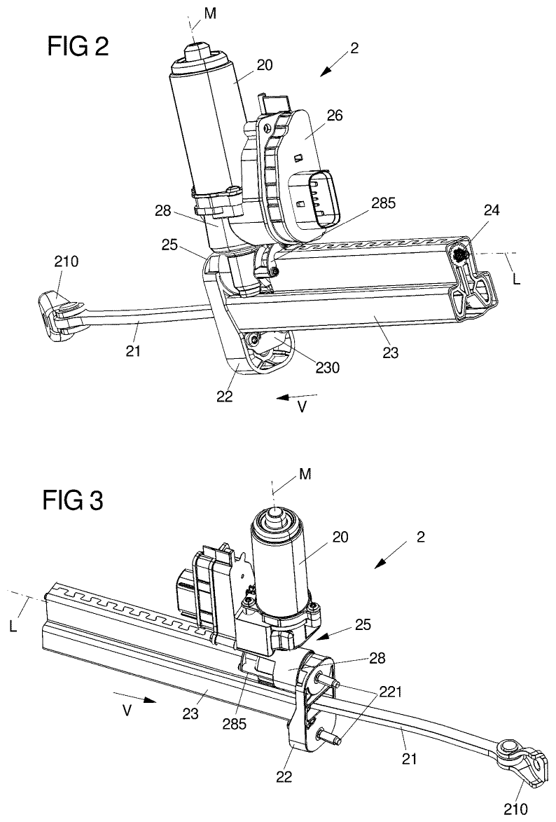

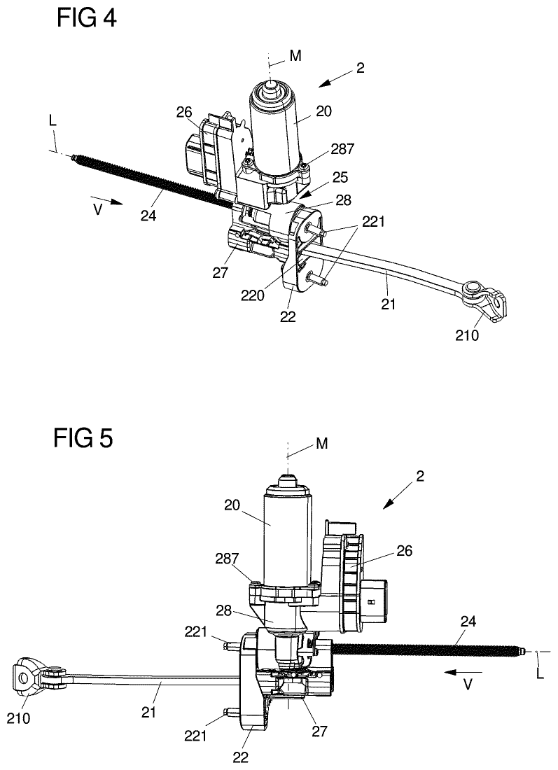

FIGS. 2-15 show views of an exemplary embodiment of a door drive device 2, which is designed to adjust a vehicle door 11 relative to a vehicle body 10. The door drive device 2 has a motor 20, a push rod 21, an adapter element 22, a guide rail 23, a spindle 24, a transmission 25, a control unit 26 and a housing assembly 28 realizing a transmission housing.

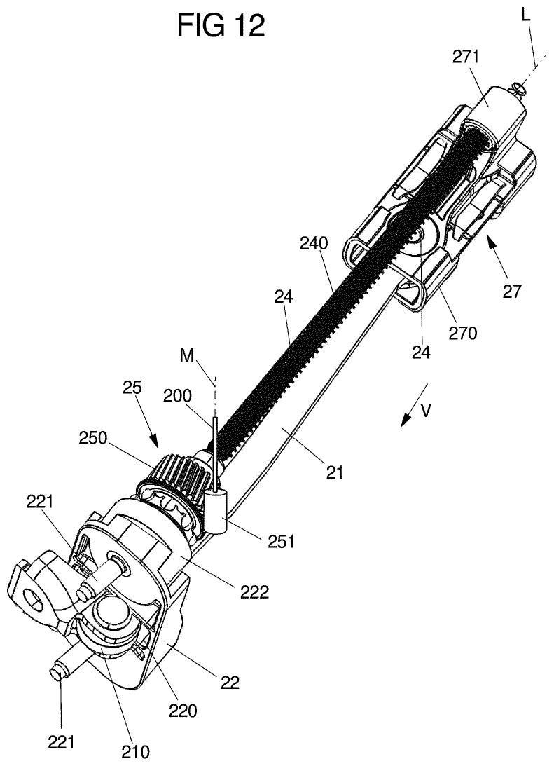

The spindle 24 extends longitudinally along a longitudinal axis L and is rotatable about the longitudinal axis L relative to the housing assembly 28. As can be seen, for example, in FIG. 12, a gear wheel 250 in the form of a spur gear of the transmission 25 is connected to the spindle 24 for conjoint rotation. The gear wheel 250 engages with a drive worm 251, schematically shown in FIG. 12 and arranged on a motor shaft 200 of the motor 20, in such a way that, by rotating the motor shaft 200 with the drive worm 251 arranged on it, the gear wheel 250 can be rotated about the longitudinal axis L, and thus the spindle 24 can be set into a rotary motion about the longitudinal axis L.

A spindle nut element 27 is arranged on the spindle 24 and has a spindle nut portion 271 and a sliding portion 270. The spindle nut element 27 is guided in the guide rail 23 via the sliding portion 270. The spindle nut portion 271 forms a threaded opening through which the spindle 24 engages and which engages with an external thread 240 of the spindle 24. The thread engagement is such that when the spindle 24 is rotated about the longitudinal axis L, the spindle nut element 27 is adjusted longitudinally along the longitudinal axis L on the spindle 24.

The push rod 21 is articulatedly connected to the spindle nut element 27 at one end 211. By contrast, at one end located away from the end 211, the push rod 21 is articulatedly connected to a connection element 210, via which the push rod 21 (when the door drive device 2 is arranged on the vehicle door 11) can be connected to the vehicle body 10, so that, in an operational state, the push rod 21 is supported in a vehicle 1 between the vehicle door 11 on the one hand and the vehicle body 10 on the other, and the vehicle door 11 can be moved relative to the vehicle body 10 by moving the spindle nut element 27 and by moving the push rod 21 accordingly.

FIGS. 2-5 show the door drive device 2 with the push rod 21 in an extended position, in which the spindle nut element 27 is approached by the housing assembly 28 and the push rod 21 is extended accordingly in an adjustment direction V.

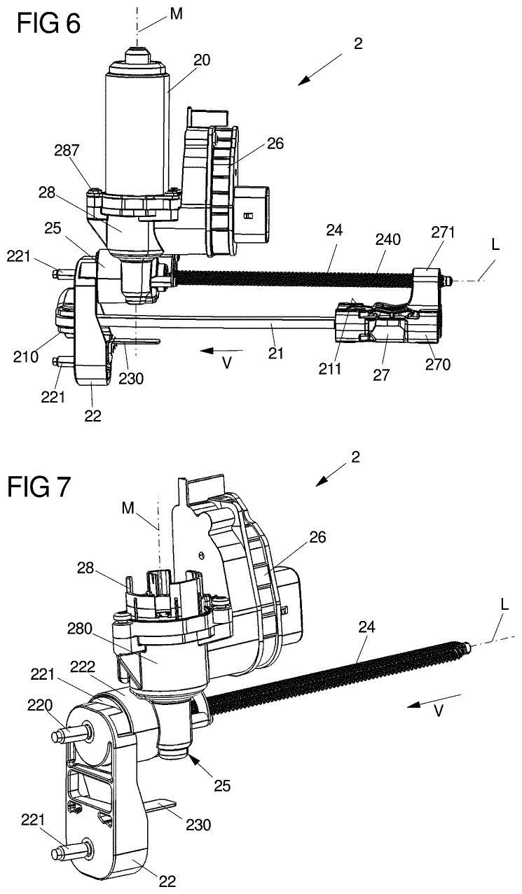

By contrast, FIG. 6 shows the push rod 21 in a retracted position, in which the spindle nut element 27 is removed from the housing assembly 28 in the opposite direction of adjustment V and the push rod 21 is accordingly retracted into the guide rail 23.

The push rod 21 extends through an opening 220 in the adapter element 22 and can be moved relative to the adapter element 22 by moving the spindle nut element 27.

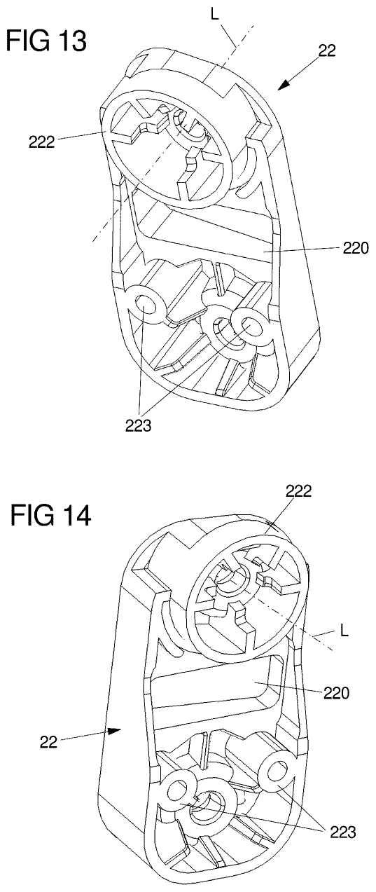

The guide rail 23 is connected to the adapter element 22 at a fastening interface 223, as can be seen from FIGS. 2 and 3 in conjunction with FIGS. 13 and 14. The guide rail 23 can be attached to the adapter element 22 via a mounting bracket 230 (see FIGS. 6 and 7), in particular screwed in place, so that the guide rail 23 is fixed relative to the adapter element 22.

In a mounted position, the housing assembly 28 is also attached to the adapter element 22. The housing assembly 28 forms a motor interface 287 to which the motor 20 is attached-for example, by screwing the motor 20 to the housing assembly 28.

The housing assembly 28 encloses the transmission 25, in particular the drive worm 251 and the gear wheel 250, and mounts them rotatably. The housing assembly 280 has a drive worm housing 282, within which the drive worm 251 is accommodated. In a housing portion 283, a shaft opening 284 is formed into which the motor shaft 200 of the motor 20 engages. For example, in the housing portion 283, a sensor system for detecting a position and/or movement of the motor shaft 200 can be arranged—for example, an arrangement of Hall sensors.

The adapter element 22 serves to connect the door drive device 2, in the illustrated exemplary embodiment, to the vehicle door 11. For this purpose, fastening elements 221 in the form of screws are arranged on the adapter element 22, via which the adapter element 22 can be screwed to the door inner panel 113 on the inside of the door box enclosed by the vehicle door 11.

While the door drive device 2 can use identical parts with respect to the housing assembly 28 and the guide rail 23 and other functional components (apart from the adapter element 22) for use in different vehicle models, the adapter element 22 represents a vehicle model-specific component that is adapted for use in a particular vehicle model and thus forms a model-specific interface designed according to the wishes of a vehicle manufacturer for attaching the door drive device 2 in the vehicle for example, on the vehicle door 11 of the specific vehicle model.

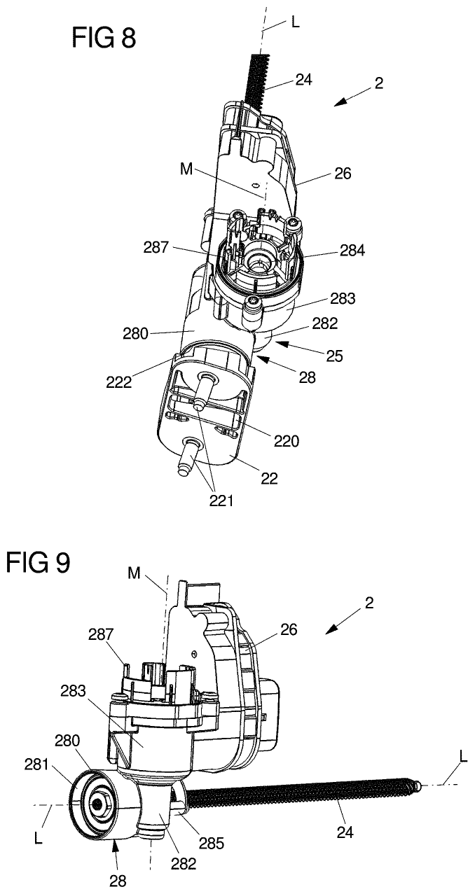

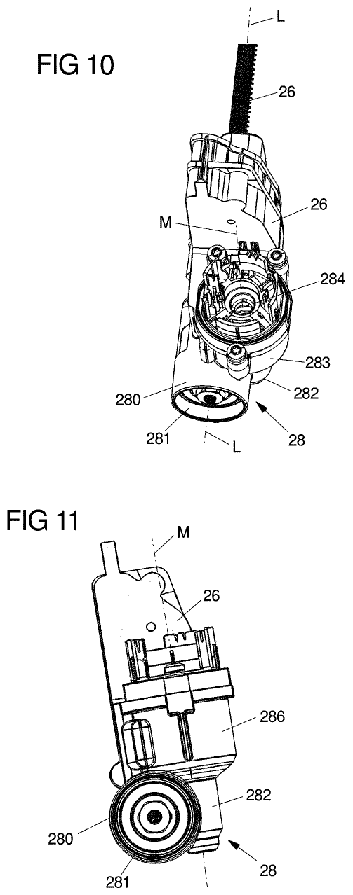

In a pre-assembly state, the housing assembly 28 is separate from the adapter element 22. The housing assembly 28 forms an attachment portion 280 which, as can be seen in particular from FIGS. 8-11, has a hollow cylindrical shape that is concentric to the longitudinal axis L. Within the attachment portion 280 an opening 281 is formed, as can be seen, for example, in FIGS. 10 and 11.

For assembly, the housing assembly 28 can be attached to an attachment portion 222 of the adapter element 22. As can be seen from FIGS. 12-14, the attachment portion 222 is formed as a cylindrical pin on the adapter element 22 and is designed to be complementary to the attachment portion 280 of the housing assembly 28, such that the attachment portion 280 can be fitted onto the attachment portion 222 and the attachment portion 222 can thus engage in the opening 281 within the attachment portion 280 of the housing assembly 28.

By attachment of the attachment portions 222, 280 of the adapter element 22 and the housing assembly 28, the adapter element 22 and the housing assembly 28 can be positioned against each other for mounting the door drive device 2. Due to the cylindrical shape of the attachment portions 222, 280, the adapter element 22 and the housing assembly 28 can be rotated relative to each other about the longitudinal axis L after the attachment portions 222, 280 have been attached to each other, in order to align the position of the motor axis M of the motor 20, about which the motor shaft 200 is rotatable, relative to the longitudinal axis L.

After the motor axis M is aligned, the attachment portions 222, 280 are firmly connected to each other—for example, by a welded connection or an adhesive connection. A welded connection can be produced, for example, by laser transmission welding, ultrasonic welding or friction welding. In other configurations it is also possible, for example, to create a screw connection between the attachment portions 222, 280 and thus to fasten the housing assembly 28 with the adapter element 22.

In the mounted, operational position, the adapter element 22 and the housing assembly 28 are firmly connected to each other, in particular rotationally fixed and positionally fixed, so that the position of the motor 20 in particular is also fixed relative to the adapter element 22.

As part of the assembly, before connecting the housing assembly 28 to the adapter element 22, when connecting the housing assembly 28 to the adapter element 22, or after connecting the housing assembly 28 to the adapter element 22, the guide rail 23 is connected to the adapter element 22. The guide rail 23 can be connected to the adapter element 22 in exactly one position. Due to the adaptability of the rotational position of the housing assembly 28 relative to the adapter element 22, the rotational position of the housing assembly 28 relative to the guide rail 23 is also variable.

The movement path of the spindle nut element 27 is defined by the guide rail 23 The movement path of the spindle nut element 27 is independent of the rotational position of the housing assembly 28 relative to the adapter element 22.

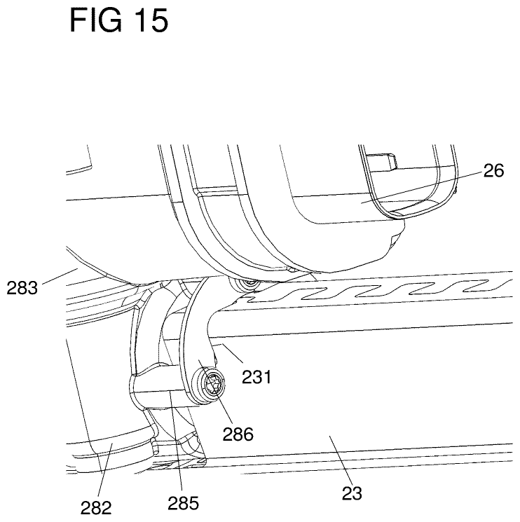

In the illustrated exemplary embodiment, a support element 285 is arranged on the housing assembly 28, by means of which axial support of the guide rail 23 relative to the housing assembly 28 is created. As can be seen from the enlarged view according to FIG. 15, the support element 285 forms a support leg 286 which extends in an arc about the longitudinal axis L and engages in an associated slot opening 231 on the guide rail 23. The support leg 286 is movable about the longitudinal axis L in the slot opening 231 relative to the guide rail 23, so that the housing assembly 28 can assume different rotational positions relative to the guide rail 23. The engagement of the support leg 286 in t he slot opening 231 provides, in particular, axial support of the guide rail 23 relative to the housing assembly 28 along the longitudinal axis L under load during operation.

The control unit 26 is used to control the door drive device 2 during operation. For example, in the control unit 26, which may have electronics for this purpose, sensor signals can be processed to detect a motor movement and a motor position and thus to detect a position or movement of the push rod 21.

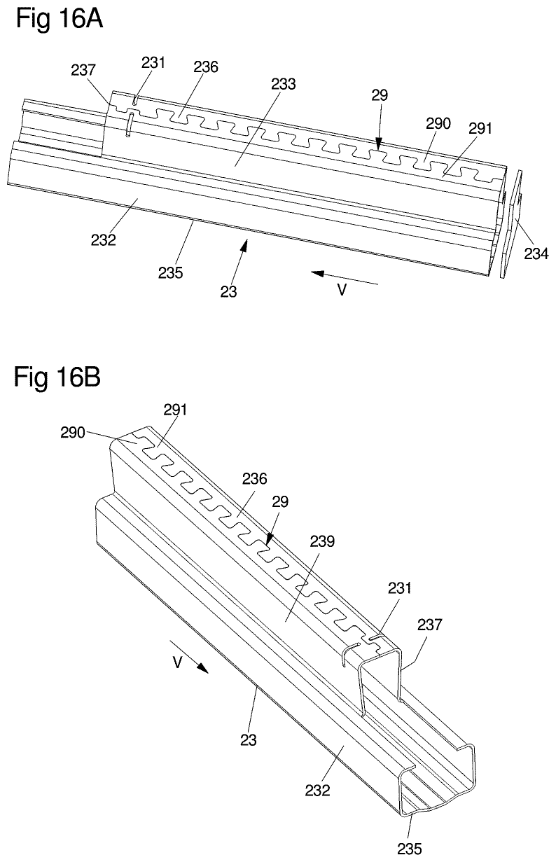

As can be seen from FIGS. 2 and 3 in conjunction with the separate views of the guide rail 23 according to FIGS. 16A and 16B, the guide rail 23 has a profile that is closed circumferentially around the adjustment direction V. Within the closed profile of the guide rail 23, the spindle nut element 27 is guided along the adjustment direction V, wherein the sliding portion 270 of the spindle nut element 27 is slidably supported in the area of a sliding guide portion 232 of the guide rail 23 and is guided along the adjustment direction V. In the area of a spindle housing portion 233, the spindle 24 extends along the longitudinal axis L. Due to the circumferentially closed profile of the guide rail 23, the spindle nut element 27 is circumferentially closed along its adjustment range in the adjustment direction V together with the spindle 24.

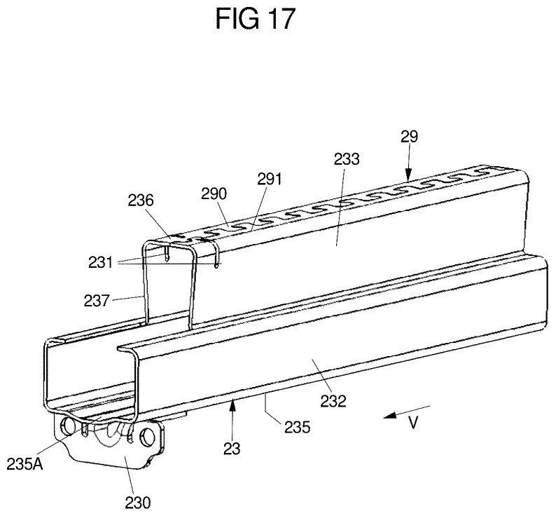

As can be seen from FIG. 17, a mounting bracket 230 is arranged on the guide rail 23 in the area of a bottom wall 235, via which the guide rail 23 is connected to the adapter element 22 in a suitably mounted position. The mounting bracket 230 can be connected to the bottom wall 235 of the guide rail 23, for example, by so-called toxing, clinching, welding or riveting.

As can be seen in FIG. 17, for example a channel 235A is formed on the bottom wall 235, in which moisture can be guided, and thus drained, from the interior of the guide rail 23 to a drainage opening in the area of a front end of the guide rail 23 facing the adapter element 22.

The guide rail 23 is closed at an axial end, located away from the housing assembly 28, by a cover element 234, as shown schematically in FIG. 16. Such a cover element 234 can be shaped as a plastic element or as a sheet metal element. The cover element 234 can be connected to the guide rail 23 by material bonding, positive connection, or non-positive connection, for example by an adhesive or welded connection, by screwing, by a clip connection, by a flange connection or a press connection.

Due to the circumferentially closed profile of the guide rail 23, the rail system of the door drive device 2 is protected from environmental conditions, in particular from dirt entering from outside during operation. Because the ingress of dirt into the interior of the guide rail 23 is prevented, advantageous sliding properties in the sliding guide of the spindle nut element 27 within the guide rail 23 can be maintained over the lifetime of the door drive device 2, with low wear and (at least approximately) constant adjusting forces.

The guide rail 23 is formed in a sheet metal bending process, in particular from a sheet of steel. The guide rail 27 is preferably formed as a punched and bent part, in which a sheet metal element is first punched into a desired shape in a punching step and then bent in a bending step so that the circumferentially closed profile of the guide rail 23 is obtained.

As can be seen from FIGS. 16A, 16B and 17, sheet metal portions 290, 291 of the formed sheet metal are bent towards each other by the sheet metal bending process and are connected to each other in the area of an upper wall 236 of the spindle housing portion 233 at a connecting point 29 which extends approximately linearly along the adjustment direction V. In particular, a closed seam is formed at the connecting point 29, through which the guide rail 23 is closed substantially fluid-tight, so that dirt, in particular dust entrained by a gust of air, cannot enter the interior of the guide rail 23 through the connecting point 29.

At the connecting point 29, the sheet metal portions 290, 291 can be joined together by any joining method, for example by a material-bonded connection, such as a welding or adhesive bond, or by a positive or non-positive connection, such as by clinching, clipping, riveting or flanging.

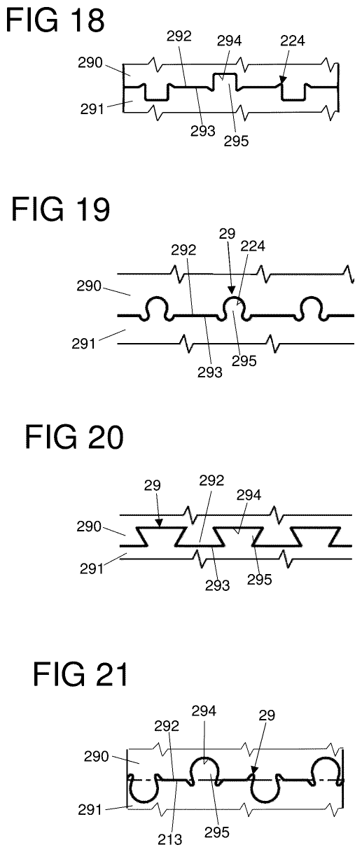

In an advantageous embodiment, the sheet metal portions 290, 291 are joined together by a so-called “roll and lock” process, in which, in one step, the sheet metal portions 290, 291 of the sheet metal forming the guide rail 23 are bent towards each other by forming in the sheet metal bending process, and joined together at the connecting point 29, as is shown in different exemplary embodiments in FIGS. 18-21. For this purpose, edges 292, 293 of the sheet metal portions 290, 291 can be butted together in the plane of the wall 236, and a positive connection between the edges 292, 293 is created via positive connection portions 295 and their engagement in associated positive connection openings 294, as shown in different exemplary embodiments in FIG. 18-21.

In the example shown in FIG. 18, the positive connection portions 295 and the complementary positive connection openings 294 have a substantially rectangular or square shape.

In contrast, in the examples according to FIGS. 19 and 21, the positive connection portions 295 and the complementary positive connection openings 294 have an omega shape.

In the example shown in FIG. 20, the positive connection portions 295 and the complementary positive connection openings 294 have a dovetail shape.

Each edge 292, 293 can have both positive connection openings 294 and positive connection portions 295, as in the examples according to FIGS. 18, 20 and 21. Alternatively, positive connection openings 294 can be formed on one edge 292, 293 and positive connection portions 295 on the other edge 293, 292, as in the example according to FIG. 19.

When joining the sheet metal portions 290, 291, the positive connection openings 294 and the positive connection portions 295 are brought into engagement with each other. This creates a fixed, permanent, substantially fluid-tight connection between the sheet metal portions 290, 291.

In addition, in the examples according to FIG. 18-21, the sheet metal portions 290, 291 can also be joined together by a material bond, for example by an adhesive bond or a welded joint, for example a laser weld.

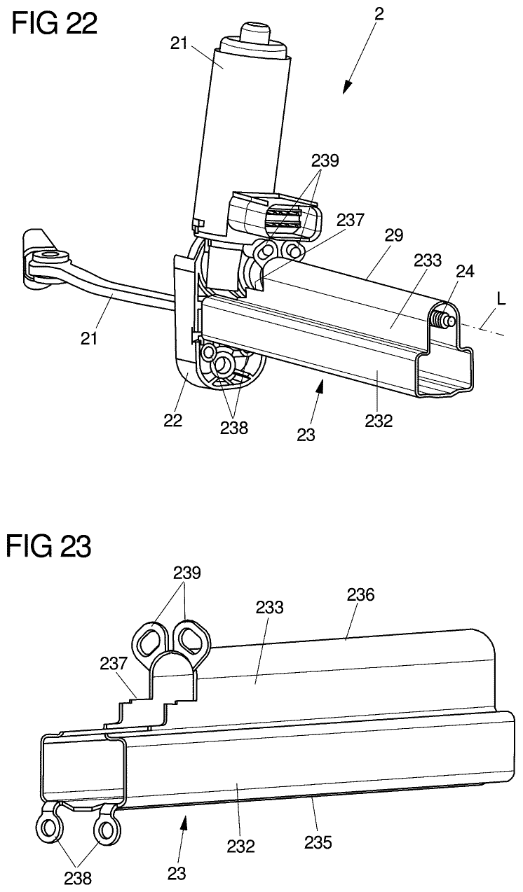

FIG. 22 or 23 show a further exemplary embodiment of a door drive device 2, which differs in particular in the design of the guide rail from the embodiment of the door drive device 2 described above with reference to FIG. 2-15, but is otherwise functionally identical to the exemplary embodiment described with reference to FIG. 2-15.

Thus, on the guide rail 23 of the exemplary embodiment according to FIGS. 22 and 23, fastening tabs 238, 239 are formed, which are each bent over on the guide rail 23 so that they extend along a plane assigned to them, perpendicular to the adjustment direction V, Each fastening tab 238, 239 has a fastening opening formed so that the guide rail 23 can be connected to the adapter element 22 (via the fastening tabs 238) and to the housing assembly 28 (via the fastening tabs 239) via the fastening tabs 238, 239.

The fastening openings on the fastening tabs 239 are formed by arcuately curved elongated holes, so that the housing assembly 28 can be connected to the guide rail 23 in different positions rotated relative to each other about the longitudinal axis L of the spindle.

In the described exemplary embodiments, a clearance 237 is formed on the guide rail 23, through which the spindle housing portion 233 is open in an axial region associated with the housing assembly 28. In the axial region of the clearance 237, the guide rail 23 is therefore not completely closed.

In the region of the clearance 237, the housing assembly 28 is attached to the guide rail 23, and a transition between the housing assembly 28 and the guide rail 23 can be sealed to be fluid-tight, for example by the guide rail 23 engaging in a complementary groove contour provided for this purpose on the housing assembly 28.

The sliding guide portion 232 extends axially into the region of the clearance 237, so that a sliding guide for the spindle nut element 27 is also provided on the guide rail 23 in the region of the clearance 237. In this way, as can be seen from FIG. 5, the spindle nut element 27 can dip under the housing assembly 28 in the extended position of the push rod 21. In particular, in the extended position of the push rod 21, in which the spindle nut element 27 is approaching the housing assembly 28, the sliding portion 270 of the spindle nut element 27 is arranged at least partially below the housing assembly 28, while the spindle nut portion 271 of the spindle nut element 27, which engages with the spindle 24, is arranged axially next to the housing assembly 28.

The spindle nut element 27 can thus axially overlap with the housing assembly 28. This results in the spindle nut element 27 being guided on the guide rail 23 over a comparatively long axial displacement path, while still maintaining a comparatively compact axial design of the door drive device 2.

The clearance 237 can be produced by punching a sheet metal element before forming, in order to then form the guide rail 23 by forming in the sheet metal bending process after the punching process.

Because of the forming in the sheet metal bending process, the guide rail 23 can be designed cost-effectively, such that in particular fastening elements for connecting the guide rail 23 with the adapter element 22 and/or the housing assembly 28 can be molded onto the guide rail 23 with a variable form.

The guide rail 23 can in particular be made from a sheet of steel.

The closed profile results in high stiffness of the guide rail 23. The material thickness of the sheet metal of the guide rail 23 can be designed to be correspondingly thin, which results in cost savings and weight savings.

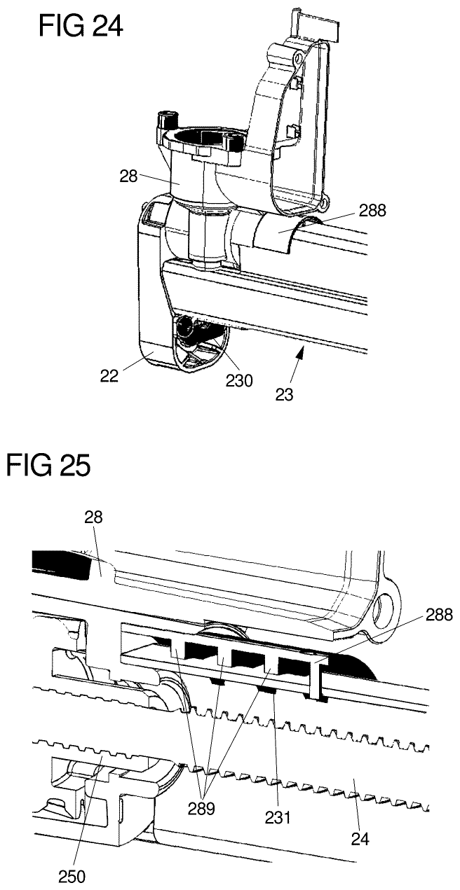

FIGS. 24 and 25 show a further exemplary embodiment in which, in modification of the exemplary embodiment according to FIG. 15, a support element 288 is fixed to the housing assembly 28. The support element 288, for example, is designed as a plastic molded part and can therefore be manufactured cost-effectively. The support element 288 is firmly connected to the housing assembly 28, e.g., in that the support element 288 is non-detachably fastened to the transmission housing 28 by means of a welded connection-for example, produced by laser transmission welding and/or ultrasonic welding.

As can be seen from the enlarged partial sectional view according to FIG. 25, the support element 288 extends in an arc shape in the area of the upper wall 236 of the guide rail 23. On one of the inner sides, facing the guide rail 23, of the support element 288, for example, arc-shaped support legs 289 are formed in the form of inwardly projecting ribs, each of which engages in an associated engagement slot 231 on the guide rail 23.

The guide rail 23 is thus supported on the transmission housing 28 via the support element 288, analogously to the exemplary embodiment according to FIG. 15, wherein the housing assembly 28 can assume different rotational positions relative to the guide rail 23 and the housing assembly 28 can thus be adapted in its angular position (about the longitudinal axis L) relative to the adapter element 22 of the guide rail 23 during assembly.

The underlying idea of the proposed solution is not limited to the previously described exemplary embodiments, but can also be realized in other ways.

In principle, a door drive device can be located on the vehicle door or the vehicle body. The push rod is supported on the other assembly in each case, so that moving the push rod can cause a relative movement between the vehicle door and the vehicle body.

### LIST OF REFERENCE SIGNS

1 vehicle
10 vehicle body
11 vehicle door
110 door outer panel
111 door module
112 door interior
113 door inner panel
114 hinge axis
2 door drive device
20 motor
200 motor shaft
21 push rod
210 connecting element
211 end
22 adapter element
220 opening
221 fastening element
222 attachment portion
223 fastening interface
23 guide rail
230 mounting bracket
231 slot opening
232 sliding guide portion
233 spindle housing portion
234 cover element
235 wall (bottom wall)
235A channel
236 wall (top wall)
237 clearance
238, 239 fastening tabs
24 spindle
240 thread
25 transmission
250 gear wheel
251 drive worm
26 control unit
27 spindle nut element
270 sliding portion
271 spindle nut portion
28 housing assembly
280 attachment portion
281 opening
282 drive worm housing
283 housing portion
284 shaft opening
285 support element
286 leg element
287 motor interface
288 support element
289 support leg
29 connecting point
290, 291 sheet metal portion
292, 293 edges
294 positive connection opening
295 positive connection portion
L longitudinal axis
M motor axis
V adjustment direction

1. A door drive device for moving a vehicle door relative to a vehicle body, having
a motor;
a transmission;
a spindle rotatable about a longitudinal axis, wherein the motor is operatively connected to the spindle via the transmission and the spindle can be driven by the motor to rotate about the longitudinal axis;
a spindle nut element which has a threaded connection to the spindle in such a way that by rotating the spindle the spindle nut element can be moved relative to the spindle along an adjustment direction oriented along the longitudinal axis;
a guide rail for guiding the spindle nut element during movement along the adjustment direction; and, and,
a push rod connected to the spindle nut element for transmitting an adjusting force between the vehicle door and the vehicle body, wherein the guide rail is formed in a sheet metal bending process and has a profile that is closed circumferentially around the adjustment direction.

2. The door drive device according to claim 1, wherein the guide rail is formed from a metal sheet, and/or the guide rail is formed from a metal sheet as a punched and bent part.

3. The door drive device according to claim 1, wherein sheet metal portions of the guide rail, which are bent towards each other about the adjustment direction, are connected to each other at a connecting point.

4. The door drive device according to claim 3, wherein
the sheet metal portions are connected to each other lengthwise along the adjustment direction at the connecting point; and/or
the sheet metal portions are positively connected, non-positively connected, or materially connected at the connecting point; and/or
the sheet metal portions are joined together at the connecting point by clinching, clipping, riveting or flanging; and/or
the sheet metal portions are joined together at the connecting point by welding or gluing.

5. The door drive device according to claim 3, wherein the edges of the sheet metal portions abut each other at the connecting point.

6. The door drive device according to claim 5, wherein
the edges of the sheet metal portions are connected to each other at the connecting point; and/or
the edges are connected to each other via positive connection portions that engage in positive connection openings.

7. The door drive device according to claim 1, wherein the guide rail is axially closed by a cover element.

8. The door drive device according to claim 1, wherein the guide rail has a sliding guide portion for slidingly guiding the spindle nut element along the adjustment direction (V), and a spindle housing portion for receiving the spindle.

9. The door drive device according to claim 8, wherein
the connecting point is located on the sliding guide portion or on the spindle housing portion; and/or
the spindle nut element has a sliding portion for sliding along the sliding guide portion; and/or
the spindle nut element has a spindle nut portion which has a threaded engagement with the spindle, wherein the spindle nut portion is movable in the spindle housing portion along the adjustment direction.

10. The door drive device according to claim 1, wherein, viewed along the adjustment direction, the guide rail has a clearance in an axial region in which the guide rail is fully open.

11. The door drive device according to claim 10, comprising a housing assembly which encloses at least one gear wheel of the transmission and carries the motor, wherein the guide rail is attached to the housing assembly in the region of the clearance.

12. The door drive device according to claim 11, wherein the guide rail has at least one first fastening tab for connection to the housing assembly.

13. The door drive device according to claim 12, wherein the at least one first fastening tab is bent on the guide rail in such a way that the at least one first fastening tab extends along a plane perpendicular to the adjustment direction.

14. The door drive device according to claim 10, wherein the housing assembly is movable about the longitudinal axis relative to the guide rail in the pre-assembly state.

15. The door drive device according to claim 14, wherein a component unit composed of the group consisting of the housing assembly and the guide rail has a support element which, in the pre-assembly state, is supported on the other component unit composed of the group consisting of the housing assembly and the guide rail in a manner movable about the longitudinal axis.

16. The door drive device according to claim 15, wherein the support element has a support leg which engages in a slot opening of the other component unit composed of the group of housing assembly and the guide rail and is movable in the slot opening about the longitudinal axis.

17. The door drive device according to claim 1, wherein the push rod is articulatedly connected to the spindle nut element.

18. The door drive device according to claim 1, comprising an adapter element for connecting the door drive device to the vehicle door or the vehicle body, wherein the adapter element has an opening through which the push rod extends in the mounted position.

19. The door drive device according to claim 18, wherein
the guide rail is connected to a fastening interface of the adapter element; and/or
the guide rail has at least one second fastening tab for connection to the adapter element.

20. The door drive device according to claim 1, wherein a channel for draining moisture is formed on a bottom wall of the guide rail.
